(19) United States
(12) Patent Application Publication
(10) Pub. No.: US 2006/0203982 A1
(43) Pub. Date: Sep. 14, 2006

(54) Method and system for auto-routing fax and voice signals

(75) Inventors: Douglas L. Robertson, Lexington, KY (US); Barry B. Stout, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/079,034

(22) Filed: Mar. 14, 2005

(51) Int. Cl. H04M 11/00

(52) U.S. Cl. 379/93.09; 379/93.05

(57) ABSTRACT

A method and system for auto-routing signals including receiving an incoming call from a sender, determining whether the incoming call includes data signals, and toggling between a fax mode and a voice mode based upon the determining step, wherein the fax mode includes receiving the data signals and the voice mode includes simulating a ring tone to the sender and routing the incoming call to at least one downstream device.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present application is directed to a signal router and, more particularly, a signal router for facsimile (i.e., fax) and voice signals.

2. Description of the Related Art

Fax machines have become commonplace in the home and office. A typical fax machine allows a user to transmit data (e.g., images) over a telephone line. Thus, fax machines must be connected to a telephone line.

Small business offices and homes typically have a single telephone line, which must be shared by the telephone and the fax machine. Therefore, a user must disconnect the telephone and connect the fax machine each time the user desires to send or receive a fax. To simplify the switching process, various toggle switches have been developed. A toggle switch allows a user to switch from telephone to fax machine and vice verse with the flip of a switch or button. However, despite the simplicity of toggle switches, users typically only turn the fax machine “on” when they intend to send or receive data.

Switching between the telephone and the fax machine has several disadvantages. For example, important incoming data transmissions may be missed when the telephone is “on” and important telephone calls may be missed when the fax machine in

Accordingly, there is a need for a fax machine capable of receiving data transmissions and telephone calls on a single line and appropriately routing the incoming call as either a data transmission (i.e., fax mode) or a telephone call (i.e., voice mode).

### SUMMARY

In one aspect, the method for auto-routing fax and voice signals includes a method for auto-routing signals including receiving an incoming call from a sender, determining whether the incoming call includes data signals, and toggling between a fax mode and a voice mode based upon the determining step, wherein the fax mode includes receiving the data signals and the voice mode includes simulating a ring tone to the sender and routing the incoming call to at least one downstream device.

Another aspect, the method for auto-routing fax and voice signals includes a method for auto-routing signals between a fax machine and a downstream device including adapting the fax machine to answer an incoming call from a sender, simulating a first ring tone to the sender, monitoring the incoming call for data signals, and simulating a second ring tone to the downstream device when the incoming call does not include data signals, wherein the first and second simulated ring tones cease when the downstream device is answered.

In another aspect, an auto-routing system is provided. The routing system includes a downstream device and a fax machine adapted to receive an incoming call from a sender, determine whether the incoming call includes data signals, and route the incoming call to the downstream device when the incoming call does not include data signals, wherein the fax machine generates a first simulated ring tone to the sender and a second simulated ring tone to the downstream device when the incoming call does not include data signals.

Other aspects of the method for auto-routing fax and voice signals will be apparent from the following description, the accompanying drawings, and the appended claims.

### BRIEF DESCRIPTION OF THE DRAWINGS

FIG. 1 is a block diagram of an auto-routing system according to one aspect of the method for auto-routing fax and voice signals; and

FIG. 2 is a flow diagram of the auto-routing system of FIG. 1.

### DETAILED DESCRIPTION

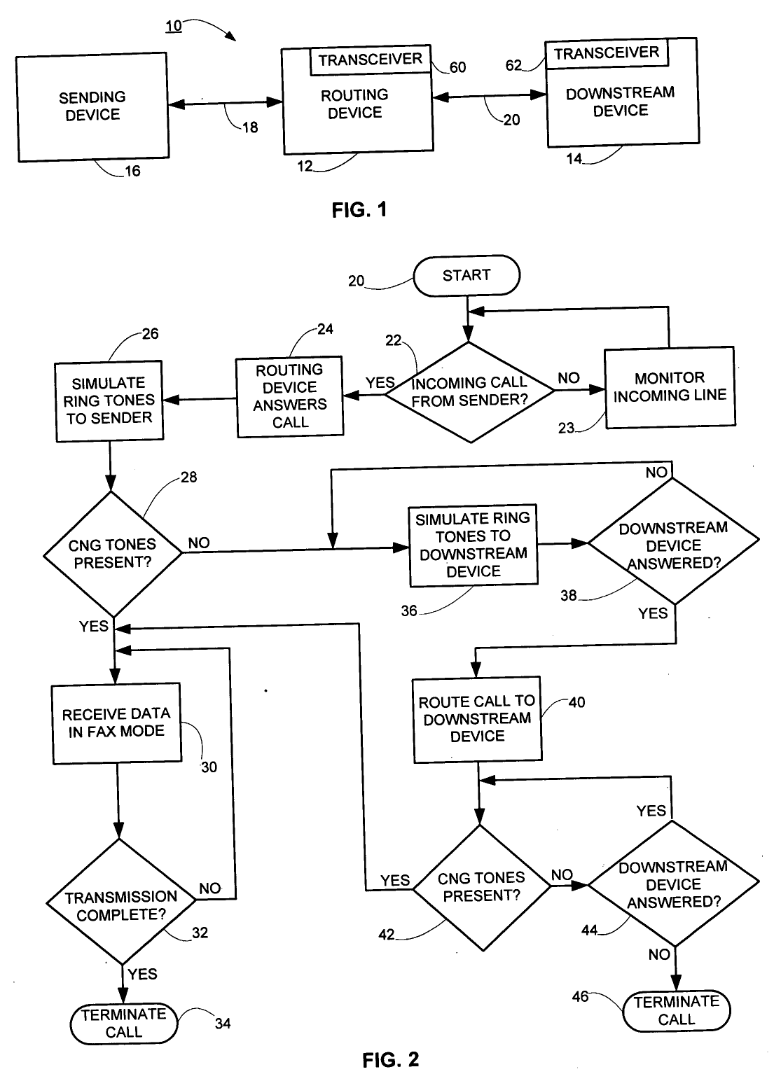

An auto-routing system, generally designated 10 in FIG. 1, includes a routing device 12, at least one downstream device 14 and a sender 16. The sender 16 may be a telephone, a fax machine or the like capable of sending the incoming call from a caller to the routing device 12. As used herein, “call” is intended to mean any signal, data stream or transmission. The routing device 12 may be a fax machine, an all in one device (i.e., a combination fax machine, copier, printer, scanner) or the like and may be connected to a telephone line 18 for receiving and answering incoming calls from the sender 16.

The downstream device 14 may be one or more telephones in communication with the routing device 12 via communication line 20. In one aspect, communication line 20 may be a hard-wired connection (e.g., a telephone wire). In another aspect, communication line 20 may be a wireless connection. In another aspect, the routing device 12 may include a base transmitting/receiving unit 60 and the downstream device 14 may include a remote transmitting/receiving unit 62 adapted to wirelessly communicate with the base transmitting/receiving unit 60, thereby allowing the downstream device 14 to wirelessly communicate with the routing device 12.

Thus, the downstream device 14 may be one or more (i.e., a plurality of) cordless telephone units adapted to receive telephone signals from the routing device 12. Alternatively, downstream device 14 may be one or more hard-wired telephone units connected directly to the routing device 12 by a telephone line wire 20.

At this point it should be understood that telephone line 18 may be a wireless connection (i.e., sender 16 may wirelessly communicate with the routing device 12).

At box 20 the auto-routing method starts. As shown in box 22 of FIG. 2, the routing device 12 may determine whether an incoming call is being communicated from the sender 16. When no incoming call is identified, the routing device 12 may at box 23 continue to monitor 23 the line 18 for incoming calls. However, when an incoming call is identified, routing device 12 answers the call (see box 24) and simulates a ring tone to the sender 16, as shown in box 26. In one aspect, the simulated ring tone is promptly presented upon answering the incoming call such that the sender 16 does not become aware that the incoming call has been answered.

As shown in box 28, upon answering the incoming call, the routing device 12 may monitor the incoming call for data signals such as CNG tones or other like tones associate with fax (i.e., data) transmissions. When the routing device 12 identifies such data signals, the routing device 12 switches to “fax mode” (i.e., the routing device determines that the incoming call is a data transmission) and receives the data transmission in a well-known way (see box 30). When the data transmission is complete (see box 32), the routing device 12 terminates the call, as shown in box 34.

As shown in box 36, when the routing device 12 does not identify data signals in the incoming call, the routing device 12 toggles to “voice mode” (i.e., the routing device determines that the incoming call is a voice transmission) and simulates a ring tone to at least one downstream device 14 (e.g., a downstream telephone rings), thereby signaling a user to answer the incoming call. The simulated ring tone to the downstream device 14 may continue until the downstream device is answered (see box 38) or the sender 16 terminates the call. In another aspect, the routing device 12 may simulate a ring tone to the sender 16 only after toggling to voice mode.

As shown in boxes 38 and 40, when a downstream device 14 is answered (i.e., picked up), the routing device 12 stops (i.e., ceases) simulating ring tones to the sender 16 and the downstream device 14 and routes the incoming call to the downstream device 14 that has been answered, thereby allowing the downstream device 14 to communicate with the sender 16.

In another aspect, as shown in box 42, the routing device 12 may include an eavesdropping function, wherein the routing device 12 continues to monitor the incoming call for data signals after toggling to voice mode. Thus, the routing device 16 can determine if an incoming call was improperly treated as a voice transmission. When data signals are identified while in voice mode, routing device 12 toggles back to fax mode and receives the data transmission as described above (see box 30).

In another aspect, as shown in box 44, the routing device 12 monitors the downstream device 14 to determine whether the downstream device is still in use (i.e., picked up). The routing device 12 terminates the call when it determines that the downstream device 14 is no longer in use (see box 46).

In another aspect, the routing device 12 may generate various unique sounds and signals to identify an incoming call as a data transmission rather than a voice transmission. Furthermore, the routing device 12 may refrain from signaling the downstream device 14 when the incoming call is a data transmission, thereby eliminating the nuisance associated with ringing when there are no voice transmissions.

In another aspect, the routing device 12 may be adapted to identify the origin of an incoming call (i.e., the routing device 12 may include a caller identification function) and route the incoming call to a specific downstream device 14 based on the origin of the incoming call. Furthermore, the routing device 12 may simulate unique ring tones to the downstream device 14 based on the origin of the incoming call, thereby allowing a downstream user to audibly identify the origin of the call prior to answering the call. Alternatively, the routing device 12 may refrain from signaling or ringing the downstream device 14 based on the origin of the call. Thus, a user may create various call block (i.e., block calls from unwanted callers) and call sort (i.e., direct calls from various callers to specific downstream devices) lists.

In another aspect, the routing device 12 may be adapted to include a warning function such that when a user picks up a downstream device 14 while the routing device 12 is receiving a data transmission (see box 30), the routing device 12 may pause the data transmission and warn the user, via the downstream device 14, that the system 10 is in fax mode and that the user should hang up the downstream device. The routing device 12 may then toggle back to fax mode and continue receiving the data transmission once the downstream device 14 is hung up.

Although the method for auto-routing fax and voice signals is shown and described with respect to certain embodiments, it is obvious that modifications will occur to those skilled in the art upon reading and understanding the specification. The method for auto-routing fax and voice signals includes all such modifications and is limited only by the scope of the claims.

What is claimed is:

1. A method for auto-routing signals comprising:
receiving an incoming call from a sender;
determining whether said incoming call includes data signals;
toggling between a fax mode and a voice mode based upon said determining step, wherein said fax mode includes receiving said data signals and said voice mode includes simulating a first ring tone to said sender, simulating a second ring tone to at least one downstream device and routing said incoming call to said downstream device when said downstream device is answered; and
after said downstream device is answered, repeating said determining step.

2. The method of claim 1 wherein said determining step includes detecting CNG tones.

3. The method of claim 1 wherein said data signals include data associated with a fax transmission.

4. (canceled)

5. The method of claim 1 wherein said simulated ring tone to said sender and said simulated ring tone to said downstream device cease when said downstream device is answered.

6. The method of claim 1 wherein said downstream device is one of a wired telephone, a cordless telephone and a wireless telephone.

7. (canceled)

8. The method of claim 1 further comprising toggling to said fax mode when said data signals are detected while said downstream device is answered.

9. The method of claim 1 further comprising generating a signal while in said fax mode.

10. The method of claim 9 further comprising generating said signal in response to a said downstream device being picked-up.

11. The method of claim 1 wherein said incoming call is received over a telephone line.

12. The method of claim 1 further comprising identifying an origin of said incoming call and routing said incoming call to a particular downstream device based upon said identification when in said voice mode.

13. A method for auto-routing signals between a fax machine and a downstream device comprising:
answering via said fax machine an incoming call from a sender;
simulating a first ring tone to said sender;
determining whether said incoming call includes data signals; and
simulating a second ring tone to said downstream device when said incoming call does not include said data signals,
wherein said first and second simulated ring tones cease when said downstream device is answered; and
after said downstream device is answered, repeating said determining step.

14. The method of claim 13 wherein said determining step includes detecting CNG tones.

15. The method of claim 13 wherein said downstream device is one of a wired telephone, a cordless telephone and a wireless telephone.

16. The method of claim 16 further comprising generating a signal while in said fax mode in response to a said downstream device being picked-up.

17. The method of claim 13 further comprising switching to said fax mode when data signals are detected after said downstream device is answered.

18. An auto-routing system comprising:
a downstream device; and
a fax machine adapted to receive an incoming call from a sender, determine whether said incoming call includes data signals, route said incoming call to said downstream device when said incoming call does not include data signals, receive the data signals when said incoming call does include said data signals and monitor said incoming call for data signals after said incoming call is routed to said downstream device;
wherein said fax machine generates a first simulated ring tone to said sender and a second simulate ring tone to said downstream device when said incoming call does not include data signals.

19. The system of claim 18 wherein said downstream device is one of a wired telephone, a cordless telephone, and a wireless telephone.

20. The system of claim 18 wherein data signals include CNG tones.
